(19) United States
(12) Patent Application Publication
(10) Pub. No.: US 2026/0220415 A1
(43) Pub. Date: Jul. 30, 2026

(54) MAGNETIC MARKER

(71) Applicant: Aichi Steel Corporation, Tokai-shi, Aichi (JP)

(72) Inventors: Tetsuya IWASE, Tokai-shi, Aichi (JP); Takashi SHIMOTO, Tokai-shi, Aichi (JP)

(73) Assignee: Aichi Steel Corporation, Tokai-shi, Aichi (JP)

(21) Appl. No.: 18/877,344

(22) PCT Filed: Jun. 28, 2023
(86) PCT No.: PCT/JP2023/024064

§ 371 Date: Dec. 20, 2024

(30) Foreign Application Priority Data
Jun. 29, 2022 (JP) 2022-104660

(51) Int. Cl. G06K 19/077; H01Q 1/22; H01Q 19/02

(52) U.S. Cl. CPC G06K 19/077; H01Q 1/22; H01Q 19/02

(57) ABSTRACT

A wireless tag is attached to one end portion of both end portions of a columnar-shaped magnetic marker. On an outer surface of the magnetic marker, an antenna made of a conductive material for amplifying radio waves transmitted and received by the wireless tag is provided. The antenna includes an intermediate portion provided to extend along an axial direction on an outer side surface of the magnetic marker and antenna end portions provided to electrically extend from the intermediate portion and forming electrical open ends at the one end portion and an other end portion of both end portions of the magnetic marker.

### TECHNICAL FIELD

The present invention relates to a magnetic marker to be laid in a road.

### BACKGROUND ART

Conventionally, magnetic markers arranged along a lane where vehicles travel to provide vehicle driving assistance have been known (for example, refer to Patent Literature 1). With the use of the magnetic markers, various driving assistances can be achieved, for example, automatic steering control (lane keep assist) for causing vehicles to travel along the lane, lane departure warning for warning of vehicle's departure from the lane, and automatic driving.

When a vehicle detects a magnetic marker, if that magnetic marker is uniquely identified, for example, the position of the vehicle can be grasped with reference to the position of that magnetic marker. Thus, a magnetic marker retaining a wireless tag for transmitting identification information and so forth has been suggested (for example, refer to Patent Literature 2). On the vehicle side, it is possible to identify the detected magnetic marker by using the identification information transmitted from the wireless tag.

### CITATION LIST

### Patent Literature

Patent Literature 1: Japanese Unexamined Patent Application Publication No. 2005-202478
Patent Literature 2: Japanese Unexamined Patent Application Publication No. 2019-125136

### SUMMARY OF INVENTION

### Technical Problem

However, the above-described conventional magnetic marker retaining the wireless tag has the following problem. That is, there is a possibility that radio waves transmitted and received by the wireless tag become unstable in accordance with the ambient environment.

The present invention was made in view of the above-described conventional problem, and it is intend to provide a magnetic marker, retaining a wireless tag, in which a communication performance of the wireless tag is improved.

### Solution to Problem

The present invention resides in a columnar-shaped magnetic marker to be disposed in a traveling road of a vehicle, the magnetic marker comprising:
a wireless tag attached to one end portion of both end portions of the columnar-shaped magnetic marker; and
an antenna provided on an outer surface of the magnetic marker and made of a conductive material for amplifying radio waves transmitted and received by the wireless tag, wherein
the antenna includes i) an intermediate portion provided to extend along an axial direction on an outer circumferential side surface of the magnetic marker, and ii) antenna end portions provided to electrically extend from the intermediate portion and forming electrical open ends at the one end portion and an other end portion of the both end portions of the magnetic marker.

The magnetic marker of the present invention is the columnar-shaped magnetic marker with the wireless tag attached to the end portion. This magnetic marker includes the antenna for amplifying radio waves transmitted and received by the wireless tag. The antenna is configured to include the intermediate portion provided on the outer side surface of the magnetic marker and antenna end portions provided at both end portions of the magnetic marker to form open ends.

According to this antenna, radio waves transmitted and received by the wireless tag can be amplified. With radio waves transmitted and received by wireless tag being able to be amplified, it is possible to enhance reliability when the vehicle transmits and receives radio waves to improve communication performance. On the vehicle side, with the information of wireless tag being able to be obtained with high reliability, it is possible to construct a driving assistance system with high reliability by using magnetic marker of the present invention.

### BRIEF DESCRIPTION OF DRAWINGS

FIG. 1 is a perspective view depicting a magnetic marker.

FIG. 2 is a perspective view depicting a wireless tag.

FIG. 3 is a perspective view depicting a main body.

FIG. 4 is a perspective view depicting an antenna.

FIG. 5 is a descriptive diagram of a laying mode of the magnetic marker.

FIG. 6 is a descriptive diagram of antenna shape A of the present embodiment.

FIG. 7 is a descriptive diagram of antenna shape B.

FIG. 8 is a descriptive diagram of antenna shape C.

FIG. 9 is a descriptive diagram of antenna shape D.

FIG. 10 is a descriptive diagram of antenna shape E.

FIG. 11 is a descriptive diagram of antenna shape F.

FIG. 12 is a descriptive diagram of antenna shape G.

FIG. 13 is a descriptive diagram of antenna shape H.

FIG. 14 is a descriptive diagram of antenna shape I.

FIG. 15 is a descriptive diagram of performance evaluation experiments.

FIG. 16 is a perspective view depicting another antenna.

FIG. 17 is a perspective view depicting another main body.

### DESCRIPTION OF EMBODIMENTS

Modes for implementation of the present invention are specifically described by using the following embodiments.

### First Embodiment

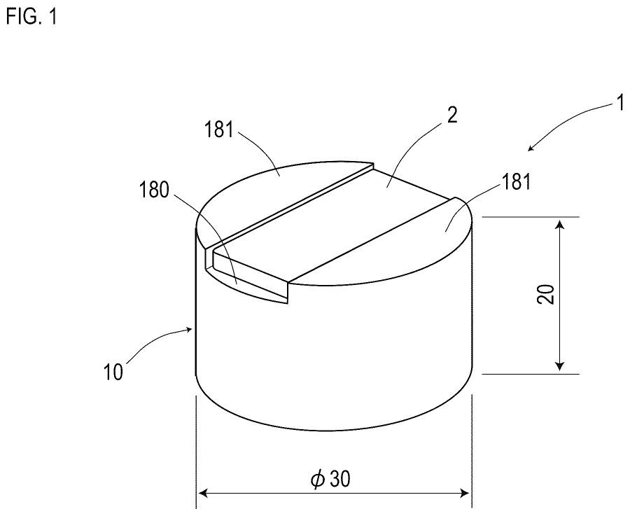

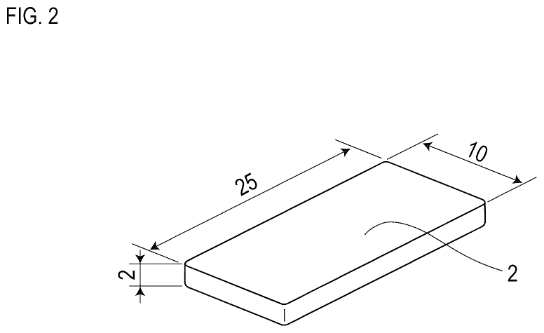

The present embodiment is an example regarding magnetic marker 1 including wireless tag (Radio Frequency IDentification, RFID tag) 2. Details of this are described by using FIG. 1 to FIG. 17.

Magnetic marker 1 is a marker for roads to be used for various driving assist controls, for example, lane departure warning, lane keep assistance, automatic driving, and so forth. Magnetic marker 1 is arranged, for example along the center of a lane. Magnetic marker 1 exemplarily depicted in FIG. 1 exhibits a cylindrical shape having a diameter (D) of 30 mm and a height (H) of 20 mm. In this magnetic marker 1, one end portion of cylinder-shaped main body 10 is provided with a space for arranging wireless tag 2.

Wireless tag 2 is an electronic component that operates by external power feed by wireless radio waves and wirelessly outputs information stored in advance. Wireless tag 2 has a housing made of a resin material or the like. Accommodated inside this housing are an IC chip, an antenna for wireless communication, and so forth. The outer shape of wireless tag 2 is a strip shape having a sectional shape of 10 mm×2 mm and a length of approximately 25 mm. Wireless tag 2 outputs information, for example, position information and road type.

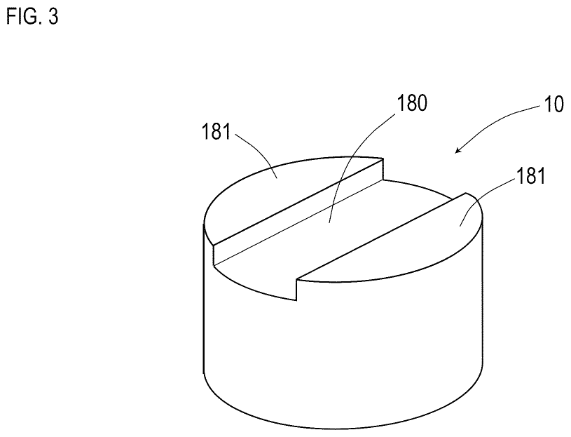

Main body 10 of magnetic marker 1 (FIG. 3) is an anisotropic ferrite plastic magnet having magnetic powder of iron oxide as a magnetic material dispersed into a polymer material as a base material. Main body 10 is, for example, an injection-molded product made of the polymer material with magnetic powder being dispersed. As the polymer material, for example, Nylon 12, PPS (Poly Phenylene Sulfide), Nylon 66, or the like can be adopted. An isotropic ferrite rubber magnet adopting rubber as the polymer material may be taken as main body 10.

Main body 10, which is a permanent magnet, has a magnetic characteristic of maximum energy product (BHmax)=14.9 kJ/cubic meter. Having magnetic powder dispersed into a nonconductive polymer material, main body 10 exhibits an electrical characteristic of low electrical conductivity. Thus, there is less possibility that eddy current occurs in main body 10 due to radio waves transmitted and received by wireless tag 2. By suppressing eddy current due to radio waves transmitted and received by wireless tag 2, it is possible to suppress attenuation of radio waves transmitted and received by wireless tag 2. Note that magnetic flux density Gs of the surface of magnetic marker 1 including main body 10 is 275 mT (milliteslas).

At an end portion of main body 10, groove 180 penetrating in a radial direction is provided. The end portion of main body 10 where groove 180 is provided is an end portion of magnetic marker 1. Groove 180 is formed so as to be able to accommodate strip-shaped wireless tag 2 described above. Groove 180 is a space formed as being interposed by tag guards 181 provided to stand on both sides. Tag guards 181 on both sides protrude in an axial direction than wireless tag 2 accommodated in groove 180, and are useful for protection of wireless tag 2. Tag guards 181 may be integrally provided at the time of injection molding of main body 10, or may be provided by cutting groove 180 in a flat end surface after injection molding. Furthermore, piece-shaped tag guards may be fabricated separately from the main body and bonded or the like to a flat end face of the main body.

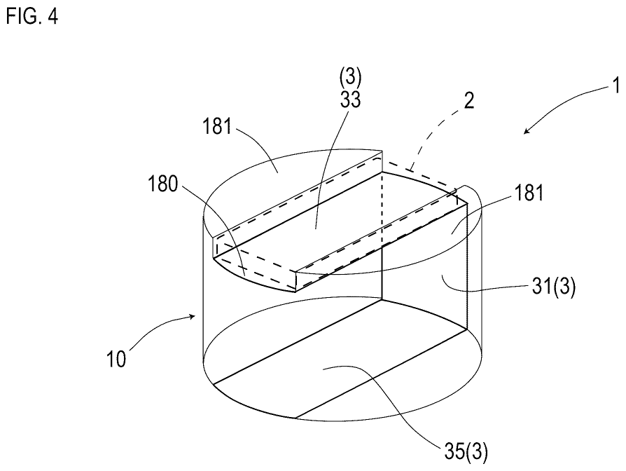

Furthermore, on an outer surface of main body 10, antenna 3 (FIG. 4) formed of a thin film made of a conductive material (conductive film) is disposed. Antenna 3 of the present embodiment is formed of a conductive film of an aluminum thin film having a thickness of 0.03 mm. As described above, main body 10 has an electric characteristic of low electric conductivity. Thus, antenna 3 is not electrically conductive to main body 10.

Note that, in place of antenna 3 formed of the aluminum thin film of the present embodiment, the antenna may be formed of a metal-made thin film, such as a copper thin film. The antenna may be printed with conductive ink. As conductive ink, in addition to sliver paste, any of graphite paste, silver chloride paste, copper paste, nickel paste, and so forth can be used. Furthermore, the antenna can be formed by copper etching, metal plating, or the like.

Antenna 3 has intermediate portion 31 provided to extend along the axial direction on the outer side surface of magnetic marker 1 (main body 10) and antenna end portion 33 and 35 formed on both end portions of magnetic marker 1 (main body 10). The shape of antenna 3 developed to a plane is a tape shape having a width of 10 mm.

Antenna end portion 33 is provided so as to cover the almost entire bottom surface of groove 180. On magnetic marker 1, wireless tag 2 is attached to a surface of the antenna end portion 33. Antenna end portion 35 is disposed on an end face of main body 10 opposite to wireless tag 2. Antenna end portion 35 has dimensional specifications common to antenna end portion 33. While antenna end portions 33 and 35 are integrated with intermediate portion 31 and electrically coupled to intermediate portion 31, their end portion on a side away from intermediate portion 31 is an open end.

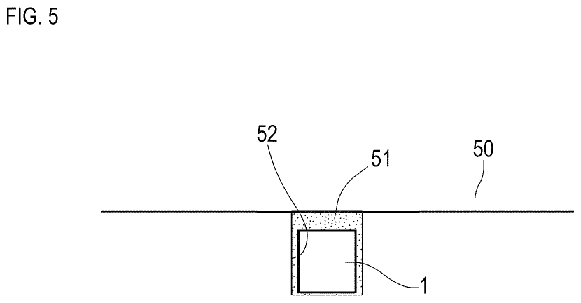

Magnetic marker 1 of the present embodiment configured as described above is laid by using accommodation hole 52, for example, bored in road surface 50 (FIG. 5). After magnetic marker 1 is accommodated, accommodation hole 52 is filled with curing-type resin material 51. As a resin material for filling, for example, a rapid-curing-type resin-based crack filler or the like for use in repair of a paved surface with a crack or the like can be used.

Magnetic marker 1 laid as described above acts with magnetism exceeding 8 μT at a height in a range of 100 mm to 250 mm assumed as an attachment position of a magnetic sensor on a vehicle side. For magnetism exceeding 8 μT, for example, measurement with high reliability can be made by a sensor such as a MI (Magneto Impedance) sensor having a measurement range of magnetic flux density of ±0.6 mT and achieving high sensitivity in the order of 0.02 μT as magnetic flux resolution in the measurement range.

In magnetic marker 1, the antenna incorporated in wireless tag 2 and antenna 3 on main body 10 side are coupled in an electrically noncontact state by electrostatic coupling, electromagnetic coupling, or the like. Antenna 3 on main body 10 side is an antenna provided on the outer surface of main body 10 as a permanent magnet. Antenna 3 functions as a booster antenna that amplifies radio waves transmitted and received by wireless tag 2. That is, in magnetic marker 1, antenna 3 provided on the outer surface of main body 10 serves as an external antenna of wireless tag 2. Antenna 3 is useful for improving reliability of wireless communication between wireless tag 2 and the vehicle side.

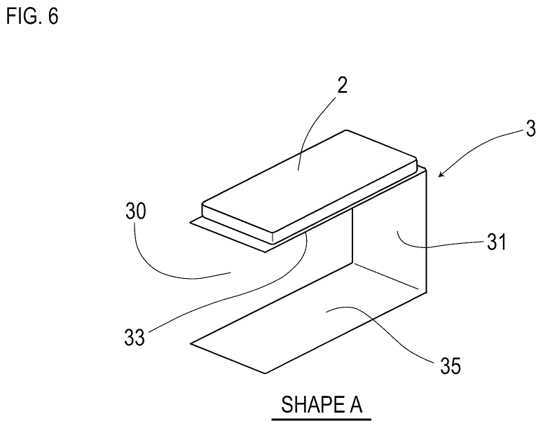

To evaluate communication performance of magnetic marker 1 of the present embodiment, the inventors compared communication performances of various antenna shapes A to I depicted in FIG. 6 to FIG. 14. Antenna shape A of FIG. 6 is the shape of the antenna of the present embodiment depicted in FIG. 4. In some of FIG. 6 to FIG. 14, depiction of the main body (reference sign 10 in FIG. 1) is omitted.

Antenna shape A of FIG. 6 is configured of, as described above, antenna end portion 33 provided on groove 180 at the end portion of magnetic marker 1, antenna end portion 35 provided at an opposite end portion, and intermediate portion 31 coupling two antenna end portions 33 and 35. In this antenna shape A, opening 30 is positioned on an outer circumferential side surface of main body 10 (refer to FIG. 4).

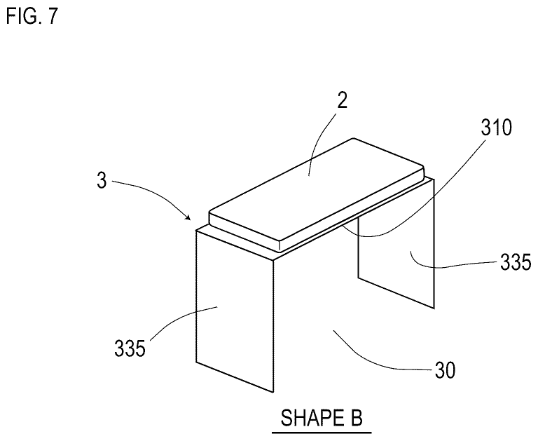

Antenna shape B of FIG. 7 has a shape formed of intermediate portion 310 along the bottom surface of the groove (reference sign 180 in FIG. 3) and two antenna end portions 335 extending in a vertical direction on the outer circumferential side surface of magnetic marker 1. Two antenna end portions 335 are provided to extend from both ends of intermediate portion 310. Antenna shape B is obtained from antenna shape A of FIG. 6 by changing the position of opening 30 downward.

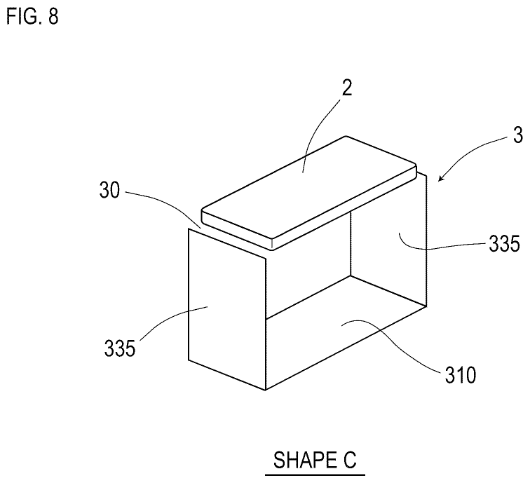

Antenna shape C of FIG. 8 has a shape obtained by turning antenna shape B of FIG. 7 upside down. In this antenna shape C, no conductive layer forming an antenna is formed on the bottom surface of the groove (reference sign 180 in FIG. 3), and wireless tag 2 is positioned in opening 30 of antenna 3.

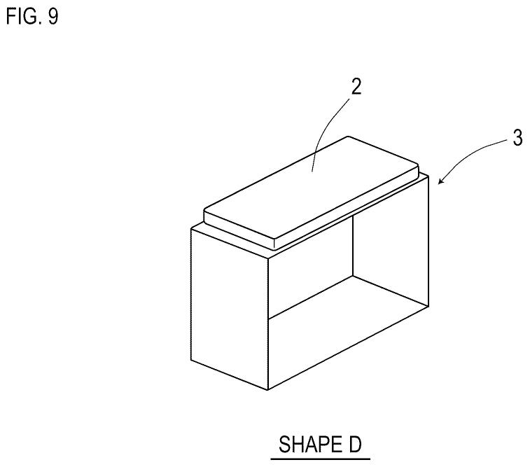

Antenna shape D of FIG. 9 has a shape forming a annular shape. Antenna shape D is a shape with the open ends of antenna end portions 33 and 35 of antenna shape A of FIG. 6 electrically coupled by the conductive layer.

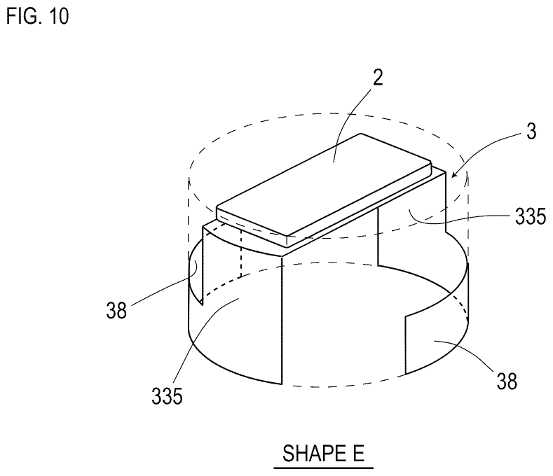

Antenna shape E of FIG. 10 is a shape obtained from antenna shape B of FIG. 7 by adding extending portions 38 each extending from an open end of each antenna end portion 335 in a circumferential direction. The directions in which two extending portions 38 extend from the open ends are the same.

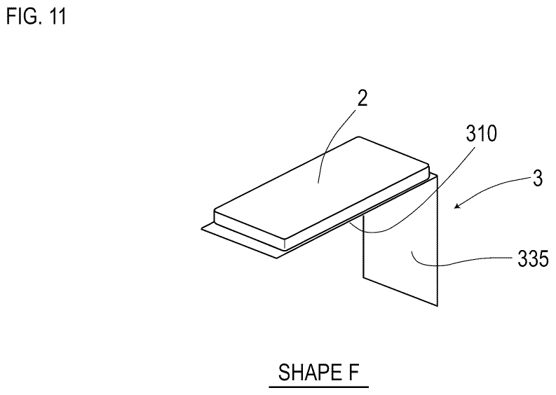

Antenna shape F of FIG. 11 is a shape obtained from antenna B of FIG. 7 by removing one antenna end portion 335.

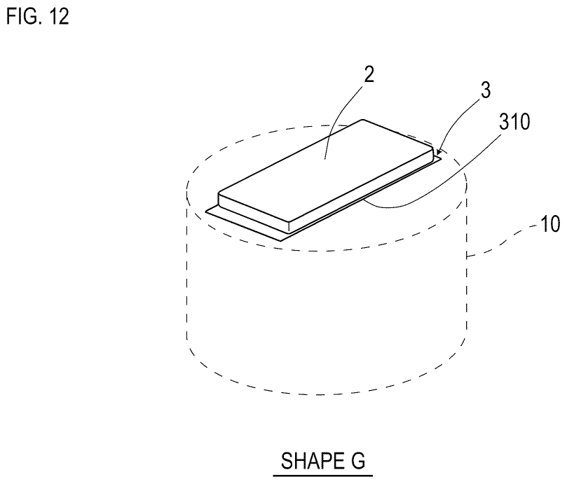

Antenna shape G of FIG. 12 is a shape based on antenna A of FIG. 6 only with intermediate portion 310 along the bottom surface of the groove (reference sign 180 in FIG. 3).

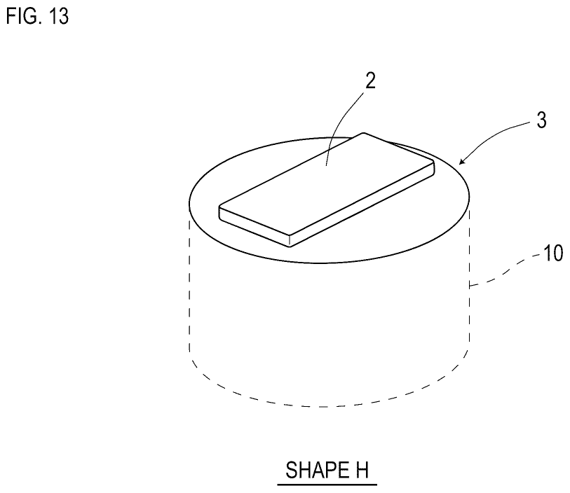

Antenna shape H of FIG. 13 is a shape for a magnetic marker (omitted in the drawing) not having the tag guard (reference sign 181 in FIG. 3) and with both end faces being flat. Antenna shape H is a shape formed of the conductive layer over the entire surface of a flat end face of the magnetic marker.

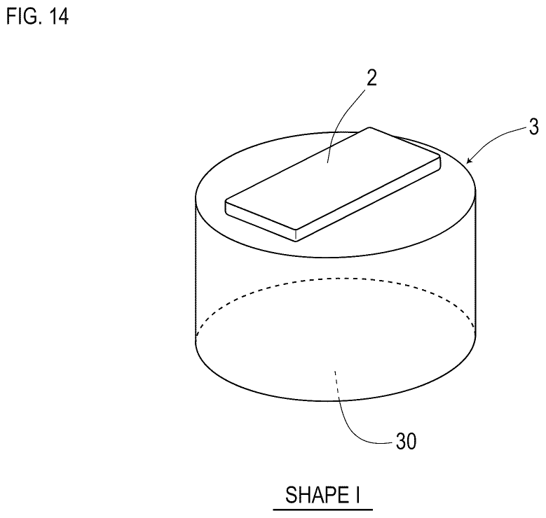

Antenna shape I of FIG. 14 is a shape, as with antenna shape H, for the magnetic marker not having the tag guard and with both end faces being flat. Antenna shape I is a shape formed of the conductive layer over the entire outer surface except one end face, which is opposite to wireless tag 2, among both end faces of the magnetic marker.

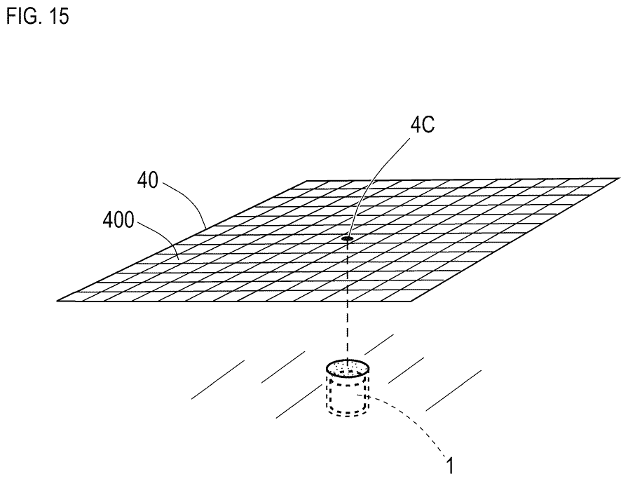

The results of the comparison of communication performances are depicted in Table 1. A communication performance experiment on each antenna shape is, as in FIG. 15, an experiment targeted for magnetic marker 1 buried in a manner by simulating a laying mode in road surface 50. In this communication performance experiment, rectangular two-dimensional area 40 is set to have lengthwise and breadthwise dimensions of ±400 mm with reference to center point 4C directly above magnetic marker 1 and at a height of 200 mm. And, in each mesh 400 sectioning this two-dimensional area 40 in a grid shape, radio field intensity outputted from wireless tag 2 was measured. Note that there is a possibility in which radio wave directivity due to the orientation of magnetic marker 1 may poses a problem. To address this, in the present embodiment, the orientation of magnetic marker 1 is changed between two direction orthogonal to each other, and radio field intensity as described above is measured for each orientation.

Evaluation items of communication performance include three items: radio field intensity, area stability, and non-directivity. The item of radio field intensity is an item obtained by evaluating average radio field intensity inside two-dimensional area 40. The item of area stability is an item obtained by evaluation in view of less variations (dispersion) of radio field intensity for each mesh 400, no occurrence of mesh 400 in which radio field intensity is deficient, and so forth. The item of non-directivity is an item obtained by evaluation in view of a small difference in a distribution of radio field intensity due to the difference in orientation of magnetic marker 1.

TABLE 1

| | RADIO | AREA | NON- |
|---|---|---|---|
| | FIELD | STA- | DIREC- |
| | INTENSITY | BILITY | TIVITY |
| ANTENNA | ⊚ | ⊚ | ⊚ |
| SHAPE A | | | |
| ANTENNA | ○ | Δ | Δ |
| SHAPE B | | | |
| ANTENNA | Δ | Δ | Δ |
| SHAPE C | | | |
| ANTENNA | ○ | Δ | Δ |
| SHAPE D | | | |
| ANTENNA | ○ | ○ | X |
| SHAPE E | | | |
| ANTENNA | ○ | Δ | Δ |
| SHAPE F | | | |
| ANTENNA | ○ | Δ | Δ |
| SHAPE G | | | |
| ANTENNA | Δ | Δ | Δ |
| SHAPE H | | | |
| ANTENNA | Δ | Δ | Δ |
| SHAPE I | | | |

As in Table 1, for antenna shape A (FIG. 6) of the present embodiment, favorable results have been obtained in all of the above-described three evaluation items.

Magnetic marker 1 (FIG. 4) of the present embodiment configured as described above is a columnar-shaped magnetic marker with wireless tag 2 attached to the end portion. This magnetic marker 1 includes antenna 3 for amplifying radio waves of wireless tag 2. Antenna 3 is configured to include intermediate portion 31 provided on the outer side surface of magnetic marker 1 and antenna end portions 33 and 35 provided at both end portions of magnetic marker 1 to form open ends.

According to this antenna 3, radio waves transmitted and received by wireless tag 2 can be effectively amplified. With radio waves transmitted and received by wireless tag 2 being able to be amplified, it is possible to enhance reliability when the vehicle transmits and receives radio waves to improve communication performance. On the vehicle side, with the information of wireless tag 2 being able to be obtained with high reliability, it is possible to construct a driving assistance system with high reliability by using magnetic marker 1 of the present invention.

Note that while the antenna of the aluminum thin film is provided directly to the outer surface of main body 10 as the permanent magnet in the present embodiment, a resin layer made of a resin material may be formed on the outer circumference of main body 10 and the antenna may be provided on a surface of the resin layer. Alternatively, the outer circumference of main body 10 formed with the antenna may be coated with a resin material and wireless tag 2 may be provided on a surface of the coating layer.

The magnetic marker may have a magnet accommodated in a container. As a container, a metal-made container or a resin-made container can be adopted. For the metal-made container, a coating layer made of a resin material is preferably provided on an outer circumference of the container. By forming an antenna formed of a conductive thin film on a surface of this coating layer, it is possible to avoid an electrical contact between the metal-made container accommodating the magnet and the antenna and achieve a state in which both are not in an electrically-conductive state.

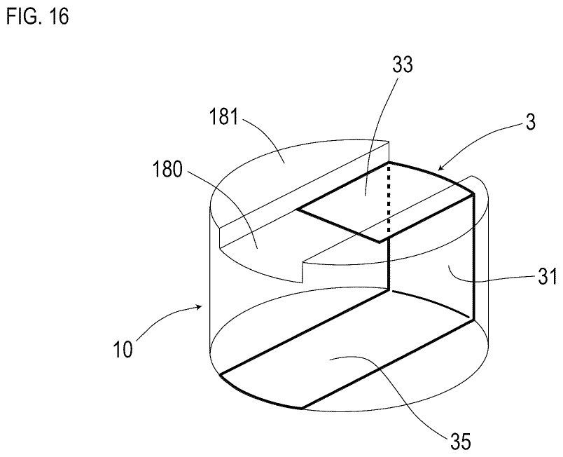

The inventors further conducted an experiment of examining communication performance by changing dimensional specifications regarding the antenna shape (refer to FIG. 4) of the present embodiment in which antenna end portions 33 and 35 are coupled by the intermediate portion 31. As a result, for antenna end portion 33 provided on the bottom surface of the groove 180, it has been found that communication performance can be ensured to some extent even if it is shortened. Although a mode is exemplarily described in the present embodiment in which antenna end portion 33 extends over the entire magnetic marker 1 in the radial direction, providing antenna end portion 33 over the entire area in the radial direction is not an imperative configuration. Even in antenna 3 exemplarily depicted in FIG. 16, communication performance can be ensured. In this antenna 3, antenna end portion 33 provided in groove 180 does not extend over the entire area in the extending direction of groove 180. The open end of this antenna end portion 33 is positioned at the midpoint in the extending direction of groove 180. Antenna end portion 33 of the drawing is provided to extend from intermediate portion 31 into groove 180 and extend to the center, which is a point on an axis of magnetic marker 1. The length of antenna end portion 33 in the radial direction may be equal to or larger than the radius of a circular section of magnetic marker 1 and equal to or smaller than the diameter thereof.

On the other hand, for antenna end portion 35 provided on the end face opposed to wireless tag 2, it has been found that, as it is longer in the radial direction, communication performance is more improved. For this antenna end portion 35, it is preferably formed over the entire area in the radial direction. As a matter of course, it can also be thought that, due to some circumstances in processing or design, it is difficult to provide antenna end portion 35 so that it extends completely to the edge of the end face. Even if a tip of antenna end portion 35 is slightly back from the edge of end face, communication performance is not greatly impaired.

Furthermore, in the present embodiment, antenna 3 having the widths of antenna end portions 33 and 35 and intermediate portion 31 being equal and exhibiting the tape shape when developed to the plane is exemplarily described. The width of antenna end portion 33 is 10 mm, which is equal to the lateral width of 10 mm of wireless tag 2. As for the width of antenna 3, although a wide width tends to improve communication performance, communication performance does not abruptly decrease even if the width is narrowed. It has been found that certain communication performance can be maintained if the width of antenna 3 is equal to or longer than 5 mm, which is half of the lateral width of 10 mm of wireless tag 2.

As a matter of course, when the width of antenna end portion 33 is narrower than the lateral width of wireless tag 2, the situation becomes such that antenna 3 (antenna end portion 33) does not face the entire bottom surface of wireless tag 2. Similarly, for example, as in FIG. 16, when the tip (open end) of antenna end portion 33 is positioned near the center of cylinder-shaped magnetic marker 1, a half area in the longitudinal direction of the bottom surface of wireless tag 2 does not face antenna 3. In this manner, it is not imperative that the entire bottom surface (attachment surface) of wireless tag 2 face the antenna 3, and the attachment state may be such that part of the bottom surface of wireless tag 2 and main body 10 as the permanent magnet face each other without antenna 3.

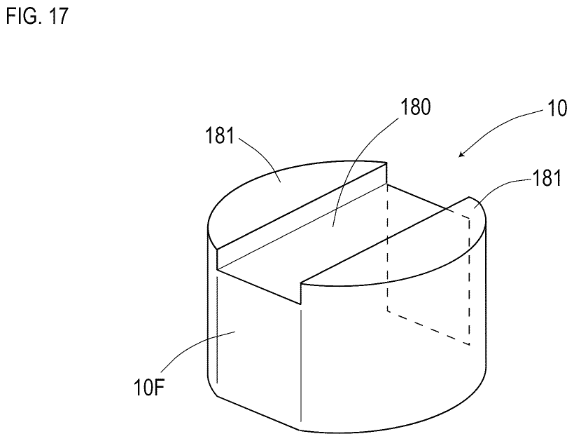

Note that when antenna 3 is provided by being affixed or the like, flat surface 10F (FIG. 17) may be formed at a location on the outer circumferential side surface of cylinder-shaped main body 10 in contact with an end portion of groove 180 (location where intermediate portion 31 is provided). Using flat surface 10F facilitates the work of affixing antenna 3. It is also preferable that flat surface 10F be provided so as to form a band shape over the entire area of cylinder-shaped main body 10 in the axial direction (height direction). In this case, the entire affix surface of antenna 3 is a flat surface. Furthermore, since a connecting location between the bottom surface of groove 180 or the end face of main body 10, which are affix surfaces of antenna end portions 33 or 35, and band-shaped flat surface 10F becomes linear, there is less possibility that a wrinkle occurs when antenna 3 is affixed. Flat surface 10F may be provided to each of the locations in contact with both ends of groove 180 (FIG. 17). In this manner, by providing flat surfaces 10F at two locations opposed to each other in the extending direction of groove 180, it is possible to avoid in advance a work of mistake of affixing intermediate portion 31 not to flat surface 10F but to a curved outer circumferential surface, thereby enhancing work efficiency.

In the foregoing, while specific examples of the present invention are described in detail as in the embodiment, these specific examples merely disclose examples of technology included in the scope of the claims. Needless to say, the scope of the claims should not be restrictively construed based on the configuration, numerical values, and so forth of the specific examples. The scope of the claims includes technologies acquired by variously modifying, changing, or combining as appropriate the above-described specific examples by using known technologies, knowledge of a person skilled in the art, and so forth.

### REFERENCE SIGNS LIST

1 magnetic marker
10 main body
180 groove
181 tag guard
2 wireless tag
3 antenna
31 intermediate portion
33, 35 antenna end portion
30 opening
4C center point
40 two-dimensional area
400 mesh
50 road surface
51 resin material
52 accommodation hole

1. A columnar-shaped magnetic marker to be disposed in a traveling road of a vehicle, the magnetic marker comprising:
a wireless tag attached to one end portion of both end portions of the columnar-shaped magnetic marker; and
an antenna provided on an outer surface of the magnetic marker and made of a conductive material for amplifying radio waves transmitted and received by the wireless tag, wherein
the antenna includes i) an intermediate portion provided to extend along an axial direction on an outer circumferential side surface of the magnetic marker, and ii) antenna end portions provided to electrically extend from the intermediate portion and forming electrical open ends at the one end portion and an other end portion of the both end portions of the magnetic marker.

2. The columnar-shaped magnetic marker in claim 1, wherein an antenna end portion of the antenna end portions is formed at the one end portion so as to include an attachment area of the wireless tag.

3. The columnar-shaped magnetic marker in claim 1, wherein a groove is provided at the one end portion for accommodating the wireless tag, and an antenna end portion of the antenna end portions is provided at a bottom surface of the groove.

4. The columnar-shaped magnetic marker in claim 3, wherein the groove has a depth deeper than a height of the wireless tag, protruding portions protruding in the axial direction of the columnar-shaped magnetic marker are formed on both sides of the wireless tag accommodated in the groove in the magnetic marker, and the wireless tag is positioned deeper in the axial direction with respect to the protruding portions.

5. The columnar-shaped magnetic marker in claim 1, wherein the magnetic marker forms a cylindrical shape, and an antenna end portion of the antenna end portions at the one end portion and an antenna end portion of the antenna end portions at the other end portion are provided to extend along a radial direction of the magnetic marker forming the cylindrical shape.

6. The columnar-shaped magnetic marker in claim 5, wherein the antenna end portions are formed at the one end portion and the other end portion so as to extend over an entire area of the magnetic marker in the radial direction.

7. The columnar-shaped magnetic marker in claim 1, wherein the antenna is formed of a layer or foil made of a conductive material.

8. The columnar-shaped magnetic marker in claim 1, wherein the magnetic marker is a permanent magnet having magnetic powder made of iron oxide dispersed into a base material made of a polymer material.

9. The columnar-shaped magnetic marker in claim 5, wherein a band-shaped flat surface over an entire area in the axial direction is formed at a location on the outer circumferential side surface of the cylinder-shaped magnetic marker where the intermediate portion is provided.

10. The columnar-shaped magnetic marker in claim 2, wherein the magnetic marker forms a cylindrical shape, and an antenna end portion of the antenna end portions at the one end portion and an antenna end portion of the antenna end portions at the other end portion are provided to extend along a radial direction of the magnetic marker forming the cylindrical shape.

11. The columnar-shaped magnetic marker in claim 3, wherein the magnetic marker forms a cylindrical shape, and an antenna end portion of the antenna end portions at the one end portion and an antenna end portion of the antenna end portions at the other end portion are provided to extend along a radial direction of the magnetic marker forming the cylindrical shape.

12. The columnar-shaped magnetic marker in claim 4, wherein the magnetic marker forms a cylindrical shape, and an antenna end portion of the antenna end portions at the one end portion and an antenna end portion of the antenna end portions at the other end portion are provided to extend along a radial direction of the magnetic marker forming the cylindrical shape.

13. The columnar-shaped magnetic marker in claim 10, wherein the antenna end portions are formed at the one end portion and the other end portion so as to extend over an entire area of the magnetic marker in the radial direction.

14. The columnar-shaped magnetic marker in claim 11, wherein the antenna end portions are formed at the one end portion and the other end portion so as to extend over an entire area of the magnetic marker in the radial direction.

15. The columnar-shaped magnetic marker in claim 12, wherein the antenna end portions are formed at the one end portion and the other end portion so as to extend over an entire area of the magnetic marker in the radial direction.

16. The columnar-shaped magnetic marker in claim 2, wherein the antenna is formed of a layer or foil made of a conductive material.

17. The columnar-shaped magnetic marker in claim 4, wherein the antenna is formed of a layer or foil made of a conductive material.

18. The columnar-shaped magnetic marker in claim 2, wherein the magnetic marker is a permanent magnet having magnetic powder made of iron oxide dispersed into a base material made of a polymer material.

19. The columnar-shaped magnetic marker in claim 4, wherein the magnetic marker is a permanent magnet having magnetic powder made of iron oxide dispersed into a base material made of a polymer material.

20. The columnar-shaped magnetic marker in claim 6, wherein a band-shaped flat surface over an entire area in the axial direction is formed at a location on the outer circumferential side surface of the cylinder-shaped magnetic marker where the intermediate portion is provided.
